(19) United States
(12) Patent Application Publication
(10) Pub. No.: US 2005/0216266 A1
(43) Pub. Date: Sep. 29, 2005

(54) Incremental adjustment of state-dependent bias parameters for adaptive speech recognition

(76) Inventors: Yifan Gong, Plano, TX (US); Xiaodong Cui, Los Angeles, CA (US)

Correspondence Address: TEXAS INSTRUMENTS INCORPORATED, P O BOX 655474, M/S 3999, DALLAS, TX, 75265, US

(21) Appl. No.: 10/811,705

(22) Filed: Mar. 29, 2004

(51) Int. Cl. G10L 15/00

(52) U.S. Cl. 704/256

(57) ABSTRACT

The mismatch between the distributions of acoustic models and features in speech recognition may cause performance degradation. A sequential bias adaptation (SBA) applies state or class dependent biases to the original mean vectors in acoustic models to take into account the mismatch between features and the acoustic models.

### FIELD OF INVENTION

This invention relates to speech recognition and more particularly to speech recognition in adverse conditions.

### BACKGROUND OF INVENTION

In speech recognition, inevitably the speech recognizer has to deal with recording channel distortions, background noises, and speaker variabilities. The factors can be modeled as mismatch between the distributions of acoustics models (HMMs) and speech feature vectors. To reduce the mismatch, speech models can be compensated by modifying the acoustic model parameters according to the amount of observations collected in the target environment from the target speaker. See Yifan Gong, “Speech Recognition in Noisy Environments”: A survey, Speech Communication, 16(3):pp261-291, April 1995.

Currently, in typical recognition systems, batch parameter estimations are employed to update parameter after observation of all adaptation data. See L. A. Liporace, Maximum likelihood estimation for multivariate observations of Markov sources, IEEE Transactions on Information Theory, IT-28(5): pp729-734, September 1982 and L. R. Rabiner, A tutorial on hidden Markov models and selected applications in speech recognition, Proceedings of the IEEE,77(2):pp257-285, February 1989. Batch processing can not track parameter variations and is therefore not suitable to follow slow time-varying environments and speaker changes. To deal with noisy background, noise statistics can be collected and used to compensate Model mean vectors. See M. J. F. Gales, PMC for speech recognition in additive and convolutional noise, Technical Report TR-154, CUED/F-INFENG, December 1993. However it is necessary to obtain an estimate of noises, which in practice is not straight forward since the noise itself may be time varying. Speaker adaptation based on MLLR improves recognition performance. See C. J. Leggetter and P. C. Woodland, Flexible speaker adaptation for large vocabulary speech recognition, IN Proceedings of European Conference on Speech Communication and Technology, Volume II, pages 1155-1158, Madrid Spain, Sept. 1955. It requires, however, that all the adaptation utterances be collected in advance. Sequential parameter estimation has been used for estimating time-varying noises in advance. See K. Yao, K. K. Paliwal, and S. Nakamura, Noise adaptive speech recognition in time-varying noise based on sequential kullback proximal algorithm, In Proc. of Inter. Conf. on Acoustics, Speech and Signal Processing, volume 1, pages 189-192, 2002. However, such formulation does not adapt the system to the speaker and channel.

### SUMMARY OF INVENTION

In accordance with one embodiment of the present invention a method of updating bias of a signal model in a sequential manner is provided by introducing an adjustable bias in the distribution parameter of the signals; updating the bias every time a new observation of the signal is available; and calculating the updated new bias by adding a correction item to the old bias.

In accordance with another embodiment of the present invention state-dependent bias vectors are added to the mean vectors and adjust them to match a given operation condition. The adjustment is based on the utterances recognized in the past, and no additional data collection is necessary.

In accordance with an embodiment of the present invention adapt bias vector parameters which can be shared , one for each Gaussian, after observing each utterance ( rather than waiting for all utterances to be available) and scan only once each utterance (single pass).

### DESCRIPTION OF DRAWING

FIG. 1 illustrates a speech recognizer according to the prior art with observing and storing N utterances and then update.

FIG. 2 illustrates Gaussian distributions by plot of amplitude in the Y axis and frequency in the x axis.

FIG. 3 illustrated the method according to one embodiment of the present invention to modify the mean vectors.

FIG. 4 illustrates all of the states in different frames tied to the same bias.

### DESCRIPTION OF PREFERRED EMBODIMENT OF THE PRESENT INVENTION

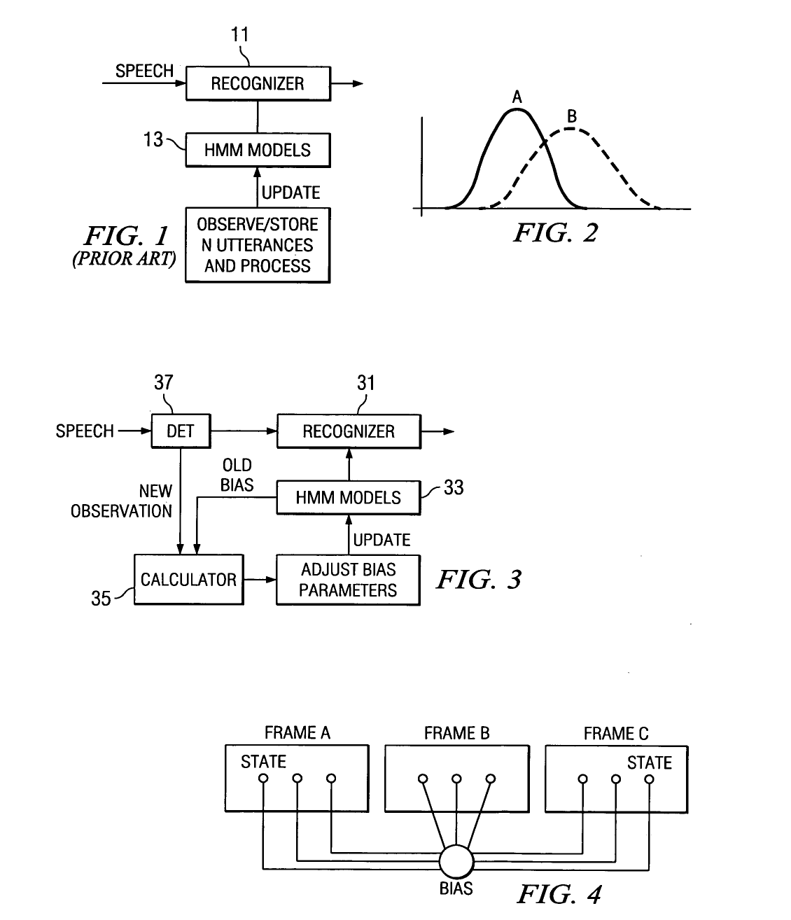

A speech recognizer as illustrated in FIG. 1 includes speech models 13 and speech recognition is achieved by comparing the incoming speech to the speech models such as Hidden Markov Models (HMMs) models at the recognizer 11. This invention is about an improved model used for speech recognition. In the traditional model the distribution of the signal is modeled by a Gaussian distribution defined by μ and Σ where μ is the mean and Σ is the variance. The observed signal Oₜ is defined by observation N (μ,Σ). Curve A of FIG. 2 illustrates a Gaussian distribution. If you have noise or any distortion such as a difference speaker or microphone channel the values change such as represented by curve B of FIG. 2. In the prior art Expectation Maximization (EM) approach the procedure is to observe the utterance N and then do an update. The formulation required a specified number of utterances is used to get a good mean bias. There is a need to collect adaptation data and noise statistics. That number may be 1000 with many speakers. This does not permit one to correct for the individuality of the speaker or account for channel changes.

The present invention provides sequential bias adaptation (SBA) introduces a bias vector to each of the mean vectors of Gaussian distributions of the recognizer 31 as shown in FIG. 3. It adapts the biases of the acoustic models online sequentially based on the sequential Expectation-Maximization (EM) algorithm. The bias vectors are updated on new speech observations, which may be the utterance just presented to the recognizer 3 1. The new speech observation may be for every sentence, every word, number dialed, or sensing a quiet and then updating. This permits correcting for the individuality of the speaker and for correcting for channel changes. For sequential bias adaptation, there is no need to explicitly collect adaptation data, and no need to collect noise statistics. The new observation is used with the old bias to calculate the new bias adjustment as illustrated by block 35 and that is used to provide the updated bias adjustment to the models 33.

The following equation (1) is the performance index or Q function. The Q function is a function of θ which includes this bias.

$${Q}_{K + 1}^{( s )} ( {Θ}_{k} , θ ) = {\sum }_{r = 1}^{K + 1} {Q}_{r} ( {Θ}_{k} , θ ) \qquad ( 1 )$$

where

$${Q}_{k + 1}^{( s )}$$

denotes the EM auxiliary Q-function based on all the utterances from 1 to k+1, in which is the parameter set at utterance k and θ denotes a new parameter set. See A. P. Dempster, N. M. Laird, and D. B. Rubin “Maximum likelihood from incomplete data via the EM algorithm. Journal of the Royal Statistical Society, 39(1):1-38, 1977.

$${Q}_{k + 1}^{( s )}$$

can be written in a recursive way as:

$${Q}_{k + 1}^{( s )} ( {Θ}_{k} , θ ) = {Q}_{k}^{( s )} ( {Θ}_{k - 1} , θ ) + {L}_{k + 1} ( {Θ}_{k} , θ ) \qquad ( 2 )$$

where [symbol] ₖ₊₁(Θₖ,θ) is the Q-function for the (k+1)th utterance, and

$${L}_{k + 1} ( {Θ}_{k} , θ ) = {\sum }_{j} {\sum }_{m} P ( {η}_{k + 1} = j , {ɛ}_{k + 1} = m \vert {y}_{1}^{k + 1} , {Θ}_{k} ) log p ( {y}_{k + 1} \vert j , m ) \qquad ( 3 )$$

Based on stochastic approximation, sequential updating equation is

$${θ}_{k + 1} = {θ}_{k} - {{[ \frac{{\partial }^{2} {Q}_{k + 1}^{( s )} ( {Θ}_{k} , θ )}{{\partial }^{2} θ} ]}_{θ = {θ}_{k}}^{- 1} [ \frac{\partial {l}_{k + 1} ( {Θ}_{k} , θ )}{\partial θ} ]}_{θ = {θ}_{k}} \qquad ( 4 )$$

This says you get the newly estimated parameter θₖ₊₁ based on θₖ minus the second derivative and the first derivative of the [symbol] function. k here is the index of the utterance. This shows that at each utterance you can update the change following the channel or speaker change.

We then apply this to the bias estimation to get sequential estimation of state-dependent biases. We introduce a state-dependent bias lⱼ attached to each state j, we express the Gaussian power density function (pdf) of the state j mixture m as

$${b}_{jm} ( {o}_{t} ) = N ( {o}_{t} ; {μ}_{jm} + {l}_{j} , {\sum }_{jm} ) \\ = \frac{1}{{( 2 π )}^{\frac{n}{2}} {\vert {\sum }_{jm} \vert}^{\frac{1}{2}}} {ⅇ}^{- \frac{1}{2} {( {o}_{t} - {μ}_{jm} - {l}_{j} )}^{T} {\sum }_{jm}^{- 1} ( {o}_{t} - {μ}_{jm} - {l}_{j} )} \qquad ( 5 )$$

This equation 5 specifies the Gaussian distribution attached to the state j and mixing component m. This equation shows at each state j we have a bias lj.

Apply the block sequential estimation formula in equation 4,

$${l}_{j}^{( k + 1 )} = {l}_{j}^{( k )} - {{[ \frac{{\partial }^{2} {Q}_{k + 1} ( {Θ}_{k} , {l}_{j} )}{{\partial }^{2} {l}_{j}} ]}_{{l}_{j} = {l}_{j}^{( k )}}^{- 1} [ \frac{\partial {L}_{k + 1} ( {Θ}_{k} , {l}_{j} )}{\partial {l}_{j}} ]}_{{l}_{j} = {l}_{j}^{( k )}} \qquad ( 6 )$$

Ignoring the items that are independent of lⱼ's we define Q-function as

$$\begin{matrix}{Q}_{k + 1} ( {Θ}_{k} , {l}_{j} ) = {\sum }_{t = 1}^{{T}^{k + 1}} {\sum }_{j} {\sum }_{m} P ( {η}_{t} = j , {ɛ}_{t} = m \vert {o}_{1}^{{T}^{k + 1}} , {Θ}_{k} ) log {b}_{jm} ( {o}_{t } ) & ( 7 ) \\ = {\sum }_{t = 1}^{{T}^{k + 1}} {\sum }_{j} {\sum }_{m} {γ}_{κ + 1} , ( j , m ) log {b}_{jm} ( {o}_{t} ) & ( 8 )\end{matrix}$$

where γ_{k+1,t}(j,m)=P(η₁=j,εₗ=m|o₁^{T}^{^{k+1}},Θₖ) is the probability that the system stays at time t in state j mixture given the observation sequence o₁^{Tk+1}. This refers to the probability P of being in state j, mixing component m given what we observe O₁ from 1 to T^{k+1} and given old HMM Σₖ.

According to the definition,

$$\begin{matrix}\frac{\partial {L}_{k + 1} ( {Θ}_{k} , {l}_{j} )}{\partial {l}_{j}} = {\sum }_{m} {\sum }_{t = 1}^{{T}^{k + 1}} {γ}_{k + 1 , t} ( j , m ) {\sum }_{jm}^{- 1} ( {o}_{t} - {μ}_{jm} - {l}_{j}^{( k )} ) & ( 9 ) \\ \frac{{\partial }^{2} {Q}_{k + 1} ( {Θ}_{k} , {l}_{j} )}{{\partial }^{2} {l}_{j}} = - {\sum }_{m} {\sum }_{t = 1}^{{T}^{k + 1}} {γ}_{k + 1 , t} ( j , m ) {\sum }_{jm}^{- 1} & ( 10 )\end{matrix}$$

Therefore we arrive at the sequential updating relation for the state-dependent biases in an utterance-by-utterance manner:

$${l}_{j}^{( k + 1 )} = {l}_{k}^{( k )} + {[ {\sum }_{m} {\sum }_{t = 1}^{{T}^{k + 1}} {γ}_{k + 1 , t} ( j , m ) {\sum }_{jm}^{- 1} ]}^{- 1} [ {\sum }_{m} {\sum }_{t = 1}^{{T}^{k + 1}} {γ}_{k + 1 , t} ( j , m ) {\sum }_{jm}^{- 1} ( {o}_{t} - {μ}_{jm} - {l}_{j}^{( k )} ) ] \qquad ( 11 )$$

In this above equation it shows at each state j we have a bias bias lⱼ. We therefore have as many biases as we have states. There could be as much as 3000 states. For some applications this is too high a number. In some applications, we teach herein to tie the biases into several classes i in order to achieve more reliable and robust estimation.

In this case, a modification of equation 11 to sum up the accumulations inside each class.

$${l}_{i}^{( k + 1 )} = {l}_{i}^{( k )} + {[ {\sum }_{j ∈ class i} {\sum }_{m} {\sum }_{t = 1}^{{T}^{k + 1}} {γ}_{k + 1 , t} ( j , m ) {\sum }_{jm}^{- 1} ]}^{- 1} [ {\sum }_{j ∈ class i} {\sum }_{m} {\sum }_{t = 1}^{{T}^{k + 1}} {γ}_{k + 1 , t} ( j , m ) {\sum }_{jm}^{- 1} ( {o}_{t} - {μ}_{jm} - {l}_{i}^{( k )} ) ] \qquad ( 12 )$$

As illustrated in FIG. 4 we have all of the states in different frames tied to the same bias.

In summary, the state-dependent bias is updated at each utterance observation k. The update consists in an additive correction, composed of two factors. The first factor is based on an average variance, weighted by the probability of occupancy. The second one is based on the average of normalized difference between the observed vector and the model (original mean vector plus a bias, which has been adjusted with the utterances observed so far), weighted by the probability of occupancy.

Referring to FIG. 3 there is illustrated the method according to one embodiment of the present invention to modify the mean vectors. The method includes introducing an adjustable bias in the distribution parameter of the signals. The detector 37 detects this parameter for every utterance. Every time a new observation of the signal is available updating the bias by calculating at calculator 35 a new updated bias by adding a correction term to the old bias. The correction term is calculated based on the information of both the current model parameters and the incoming signals. The correction term is also calculated on the information from all signals provided to the recognizer and all incoming observed signals. Therefore, every time we update we don't forget the past and the previous updates are taken into account. The signals are speech signals. As discussed previously the new available data could be based on any length, in particular, could be frames, utterances or every fixed time period such as 10 minutes of speech signal. The correction term is the product of two items: the first item could be any sequences whose limit is zero, whose summation is infinity and whose square summation is not infinity. And the second term is a summation of quantities weighted by a probability, the quantities are based on the divergence model parameter and observed signal. The bias can be defined on each HMM state as in equation 11, or can be shared among different states or can be shared by groups of states or it can be shared by all the distribution of the recognizer by tying together as in equation 12.

1. A method of updating bias of a signal model in a sequential manner, comprising the steps of:
introducing an adjustable bias in the distribution parameter of the signals;
updating the bias every time a new observation of the signal is available; and
calculating the updated new bias by adding a correction item to the old bias.

2. The method of claim 1 wherein the bias can be defined on each HMM state.

3. The method of claim 1 wherein the bias is shared among different states.

4. The method of claim 1 wherein the bias is shared by groups of states.

5. The method of claim 1 wherein the bias is shared by all the distribution of a recognizer.

6. The method of claim 1 wherein the correction term is calculated based on the information of both current model parameters and the incoming observed signals.

7. The method of claim 1 wherein the correction term is calculated based on the information of both information derived from all signals provided to the recognizer and the incoming observed signals.

8. The method of claim 1 wherein the signal comprises a speech signal.

9. The method of claim 1 wherein new available data from a new observation of the signals could be based on any length.

10. The method of claim 1 wherein new available data from a new observation is a frame.

11. The method of claim 1 wherein new available data from a new observation is an, utterance.

12. The method of claim 1 wherein new available data from a new observation is every fixed length of speech signal.

13. The method of claim 1 wherein new available data from a new observation is every 10 minutes of speech signal.

14. The method of claim 1 wherein the correction is the product of any sequence whose limit is zero, whose summation is infinity and whose square summation is not infinity and the summation of the quantities weighted by a probability, the quantities are based on the divergence of desired model parameter and observed signal.
